(19) United States
(12) Patent Application Publication
(10) Pub. No.: US 2026/0171391 A1
(43) Pub. Date: Jun. 18, 2026

(54) POSITIVE ELECTRODE SHEET AND BATTERY

(71) Applicant: ZHUHAI COSMX BATTERY CO., LTD., Zhuhai (CN)

(72) Inventors: Jiao LI, Zhuhai (CN); Jialin FANG, Zhuhai (CN)

(21) Appl. No.: 19/185,041

(22) Filed: Apr. 21, 2025

(30) Foreign Application Priority Data
Dec. 12, 2024 (CN) 2024118322963

(51) Int. Cl. H01M 4/13; H01M 4/02; H01M 4/62; H01M 10/0525; H01M 10/0587

(52) U.S. Cl. CPC H01M 4/13; H01M 4/623; H01M 4/625; H01M 10/0525; H01M 10/0587; H01M 2004/021; H01M 2004/028

(57) ABSTRACT

This application relates to the technology field of batteries, and provides a positive electrode sheet and a battery, including a positive electrode current collector and a positive electrode active material layer disposed on a surface of the positive electrode current collector. The positive electrode active material layer includes a positive electrode active material, and includes a concave-convex area including a plurality of concave portions and convex portions disposed corresponding to the concave portions. In a nitrogen environment, the positive electrode active material layer has a weight loss rate ρ in a temperature range from 35° C. to 450° C., and the ρ satisfies: 1.1%-6%.

### CROSS-REFERENCE TO RELATED APPLICATION

This application claims priority to Chinese Patent Application No. 202411832296.3, filed on Dec. 12, 2024, which is hereby incorporated by reference in its entirety.

### TECHNICAL FIELD

This application relates to the technology field of batteries, and in particular to a positive electrode sheet and a battery.

### BACKGROUND

Generally, batteries are configured as a layered structure including a plurality of electrode sheets, and the squeeze occurs between different layers of the batteries or between different parts of the same one layer. In a case of the batteries being subjected to a charging and discharging cycle, the electrode sheets will expand, thereby aggravating the above-mentioned squeeze. This squeeze can disrupt the stability of the battery's layered structure, leading to localized electrolyte shortage and poor wetting, which is readily to cause interface degradation, and even can result in safety issues such as rapid degradation of battery capacity or lithium precipitation.

### SUMMARY

This application provides a positive electrode sheet and a battery, where on the basis of ensuring structural stability of the positive electrode sheet, the technical problems of electrolyte shortage between layers and poor wetting, which may cause rapid degradation of battery capacity or lithium precipitation, in the above-mentioned prior art can be solved.

In a first aspect, this application provides a positive electrode sheet, including a positive electrode current collector and a positive electrode active material layer disposed on a surface of the positive electrode current collector, where the positive electrode active material layer includes a positive electrode active material;

the positive electrode active material layer includes a concave-convex area, and the concave-convex area includes a plurality of concave portions and convex portions disposed corresponding to the respective concave portions;

in a nitrogen environment, the positive electrode active material layer has a weight loss rate ρ in a temperature range from 35° C. to 450° C., and the ρ satisfies:

$$1.1 \% \sim 6 \% .$$

According to the positive electrode sheet as described in the first aspect of this application, since the positive electrode active material layer is provided with the concave-convex area, a local micro gap can be formed between the positive electrode sheet and the negative electrode sheet, thereby providing a spatial condition for storing more electrolyte, providing more electrolyte for long cycles of the battery, improving the wetting ability of the electrolyte in this area, and avoiding the occurrence of abnormal situations such as electrolyte shortage and poor wetting between the positive electrode and the separator. Accordingly, the cycle life of the battery is improved. Furthermore, by the formation of the concave-convex area, the surface of the positive electrode sheet is rough, so that when the battery cell expands, the convex portions can effectively support the separator, preventing the separator from being deformed by the expansion stress of the negative electrode sheet.

The positive electrode sheet is provided with the convex portions to improve the deformation ability of the positive electrode sheet. When the positive electrode sheet comes into contact with the expanded negative electrode sheet, the expansion stress of the negative electrode sheet can be effectively absorbed by the convex portions of the positive electrode sheet, and the expansion of the negative electrode sheet can be buffered during the cycle process of the battery, avoiding cracks caused by excessive expansion stress of the negative electrode sheet. Moreover, part of the expansion stress of the negative electrode sheet can be absorbed by the convex portions provided in the positive electrode sheet, allowing the negative electrode sheet not to rely entirely on the resistance of its own material during expansion. This delays the fatigue of the negative electrode material, thereby enhancing the service life of the negative electrode sheet.

In addition, since the weight loss rate of the positive electrode sheet is defined in the above-mentioned range and is used to reflect the structural stability of the positive electrode sheet, it prevents problems such as elongation of the binder in the positive electrode active material layer due to excessive pressure to form the concave-convex area during the formation of the concave-convex area in the positive electrode sheet, which reduces the effect of the binder in connecting the positive electrode active particles; or excessive compaction density during the rolling process; or power falling-off due to excessive force received by the positive electrode active material layer that is caused by the content of the binder in the positive electrode active material layer being too low. In addition, excessive content of the binder can not only affect the energy density of the positive electrode sheet, but also cause the overall structure of the positive electrode sheet to become brittle and hard and have poor overall toughness, resulting in that the positive electrode sheet is not ductile as a whole and thus is easily crushed due to excessive stress concentration during the formation of the concave-convex area. That is, by balancing the compaction density of the positive electrode sheet, the content of the binder, and the height of the convex portions to control the weight loss rate of the positive electrode sheet within this range, it can prevent the positive electrode sheet from being damaged during the formation of the concave-convex area on the basis of ensuring the energy density.

In one possible implementation, a height of a top of the convex portions from the surface of the positive electrode active material layer is h, and the h and the ρ satisfy a relationship:

$$50 < h / ρ < 3600 , and / or h = 3 μm - 40 μm .$$

In one possible implementation, the concave portions have a diameter of R, and a distance between adjacent two convex portions is L, and the R, the L, and the ρ satisfy a relationship:

$$10 < L / R / ρ < 1000 , and / or R = 1000 μm - 5000 μm , and / or L = 1500 μm - 5000 μm .$$

In one possible implementation, the positive electrode sheet has a compaction density D, and the D, the h, and the R satisfy a relationship:

$$0.004 < D * h / R < 0.12 , and / or D = 3 g / {cm}^{3} - 4.5 g / {cm}^{3} .$$

In one possible implementation, the number of the convex portions or the concave portions in a unit area of the concave-convex area is N per cm², and the N=2-25, preferably, the N=4-15.

In one possible implementation, the positive electrode active material layer includes a conductive agent, and the conductive agent includes single-walled carbon nanotubes extending into the positive electrode active material at the top of the convex portions.

In one possible implementation, adjacent two convex portions form a first projection and a second projection respectively, the first projection has a first circumscribed circle, and the second projection has a second circumscribed circle; a distance between a center of the first circumscribed circle and a center of the second circumscribed circle is L1, a distance between the first projection and the second projection is L2, and the L1 and the L2 satisfy a relationship:

$$L 1 / L 2 = 1.05 - 3 , preferably , L 1 / L 2 = 1.1 - 2.$$

In one possible implementation, the L1=3 mm-10 mm, preferably, the L1=2 mm-8 mm;
and/or, the L2-0.5 mm-8 mm, preferably, the L2=1 mm-4 mm.

In one possible implementation, the convex portions have a circumscribed ball, and the circumscribed ball includes an outer surface; a flat area is formed between two adjacent convex portions, the outer surface has a spherical radius R1, a distance between the top of the convex portions and the flat area is R3, and the R1 and R3 satisfy a relationship:

R3<R1, preferably, R3<1/5R1.

In one possible implementation, the outer surface has a surface area Q1, and a projection of the outer surface formed on the positive electrode current collector along a thickness direction of the electrode sheet has an area S1; the circumscribed ball further includes an inner surface, the inner surface has a surface area Q2, and a projection of the inner surface formed on the positive electrode current collector along the thickness direction of the electrode sheet has an area S2; the Q1 and Q2 satisfy: Q1/Q2=1.02-1.21, and/or the S1 and S2 satisfy: S1/S2=1.02-1.21.

In one possible implementation, an area sum of a projection of each of the convex portions on the positive electrode current collector is S11, and an area of the positive electrode sheet is S, and the S11 and S satisfy a relationship:

$$0.02 \leq S 11 / S \leq 0.85 .$$

In one possible implementation, the single-walled carbon nanotubes are interwoven to form a mesh structure, and the positive electrode active material at the top of the convex portions is wrapped within the mesh structure.

In one possible implementation, the single-walled carbon nanotubes have a diameter of 1 nm-1000 nm and a length of 1 μm-100 μm; and/or based on a total mass of the positive electrode active material layer, the single-walled carbon nanotubes have a mass percentage of 0.5%-5%; and/or the single-walled carbon nanotubes in the positive electrode active material layer has a thickness of 10 nm-500 nm.

In one possible implementation, the positive electrode active material includes a binder, and based on the total mass of the positive electrode active material layer, the binder has a mass percentage of 1-5 wt %; and/or the binder includes at least one of polyvinylidene fluoride, vinylidene fluoride-hexafluoropropylene copolymer, styrene-acrylate copolymer, styrene-butadiene copolymer, polyamide, polyacrylonitrile, polyacrylic acid ester, polyacrylic acid, polyacrylate, sodium carboxymethyl cellulose, polyvinyl acetate, polyethylene pyrrolidone, polyethylene ether, polymethyl methacrylate, polytetrafluoroethylene or polyhexafluoropropylene.

In a second aspect, this application provides a battery, including a separator, a negative electrode sheet and the positive electrode sheet as mentioned above, the separator is disposed between the positive electrode sheet and the negative electrode sheet, and the separator, the positive electrode sheet and the negative electrode sheet are wound in a length direction of the positive electrode sheet to form a rolled-core structure.

In one possible implementation, the negative electrode sheet includes a negative electrode current collector and a negative electrode active material layer, and the negative electrode active material layer includes a silicon-carbon composite material and/or a silicon-oxygen composite material.

In one possible implementation, along a thickness direction of the positive electrode sheet, the convex portions have a size h3, and the concave portions have a size h4, and the h3 and the h4 satisfy a relationship:

$$h 3 / h 4 = 0.2 - 1.$$

### BRIEF DESCRIPTION OF DRAWINGS

In order to illustrate the technical solutions in the embodiments of this application or in the prior art more clearly, the accompanying drawings required for describing the embodiments or the prior art will be briefly introduced below. It is obvious that the accompanying drawings in the following description are some embodiments of this application. For those skilled in the art, other drawings can also be obtained based on these drawings without creative labor.

FIG. 1 shows a schematically structural diagram of a battery according to an embodiment of this application.

FIG. 2 shows a schematically structural diagram of a positive electrode sheet according to an embodiment of this application.

FIG. 3 shows a schematically structural diagram of a convex portion according to an embodiment of this application.

FIG. 4 shows a schematically structural diagram of two adjacent convex portions of a positive electrode sheet according to an embodiment of this application.

FIG. 5 shows a side view of a positive electrode sheet according to an embodiment of this application.

### REFERENCE SIGNS

100—Positive electrode sheet; 110—Positive electrode current collector; 120—Positive electrode active material layer; 130—Positive electrode tab; 101—Concave-convex area; 102—Convex portion; 103—Concave portion; 104—Tab area; 105—End avoidance zone; 106—Double-sided area; 107—Single-sided area; 108—Head end; 109—Tail end; 1051—First avoidance zone; 1052—Second avoidance zone;
200—Negative electrode sheet; 210—Negative electrode current collector; 220—Negative electrode active material layer;
300—Separator.

### DESCRIPTION OF EMBODIMENTS

In order to make the purposes, technical solutions and advantages of the embodiments of this application clearer, the technical solutions in the embodiments of this application will be clearly and completely described with reference to the accompanying drawings in the embodiments of this application. Obviously, the embodiments described are part of the embodiments of this application, not all of the embodiments of this application. Based on the embodiments in this application, all other embodiments obtained by those skilled in the art without creative labor are within the protection scope of this application.

With the rapid development of a lithium-ion battery, the market has put forward higher demands for various performance of the lithium-ion battery. For example, when the lithium-ion battery is employed in a new energy vehicle, it is required to possess better charging rate, cycle life and safety, etc. For example, when the lithium-ion battery is employed in household appliances such as a desk lamp and a razor and electronic devices such as a mobile phone and a tablet computer, it is required to possess a higher energy density.

In recent years, new energy technology has been in a stage of rapid development, and the lithium-ion battery is also undergoing a rapid evolution. The material selection, manufacturing processes, and structural design and so on of the lithium-ion battery are continuously optimized and innovated. When designing the lithium-ion battery, the primary challenges that need to be addressed include capacity, safety, service life, etc. With the continuous exploration in materials, processes and structures, the performance of the lithium-ion battery has also been continuously improved, mainly manifested in high energy density, long cycle life, high safety and other advantages. Therefore, the lithium-ion battery is frequently used in new energy field, portable consumer electronic field, wearable electronic device field and other fields.

The cycle life, energy density, safety, and other performances of the battery are predominantly determined by the choice of materials for related components, the manufacturing process of each component, the structure of each component, the interconnection design among these components, etc. in the battery. The performances of the battery can be enhanced by optimizing and upgrading materials, manufacturing processes, structure, connection design and the like. Material selection and manufacturing process are related to the advancements in some foundational technologies and foundational science such as physics and chemistry. At the current stage of battery development, it is difficult to optimize and upgrade materials and manufacturing processes. The structure and connection design of the battery are in a constant state of upgrading and transformation. Therefore, in order to improve the performances of the battery, at the current stage, when the developments of materials and manufacturing processes are hindered, the structure and connection design of the battery can be optimized to achieve the purpose of improving the performances of the battery.

Unless otherwise specified, the battery described in this application may be a lithium-ion battery. The lithium-ion battery may be designed as a stacked structure or a rolled-core structure. The stacked structure and the rolled-core structure are both layered structures. The stacked structure refers to a layered structure formed from multiple electrode sheets and separators that are laminated. The wound structure refers to a layered structure formed by winding multiple electrode sheets and separators in multiple turns in a clockwise or counterclockwise manner. Herein, the electrode sheet may include a positive electrode sheet and a negative electrode sheet.

During the manufacturing process of the battery, for example, when the battery with the above-mentioned stacked structure and rolled-core structure is formed, the battery is generally configured as a layered structure including multiple electrode sheets, and the squeeze may occur between different layers of the battery or between different parts of the same one layer. In a case of the battery being subjected to a charging and discharging cycle, the electrode sheet will expand, thereby aggravating the above-mentioned squeeze. This squeeze can disrupt the stability of the battery's layered structure, leading to localized electrolyte shortage and poor wetting, which is readily to cause interface degradation, and even can result in safety risks such as rapid capacity decay or lithium precipitation.

Based on the above situation and problems, an embodiment of this application provides a positive electrode sheet, which can, on the basis of ensuring its structural stability, solve the technical problems of insufficient electrolyte between layers and poor wetting, which may cause rapid decline of battery capacity or lithium precipitation, in the above-mentioned prior art.

The positive electrode sheet in the embodiment of this application changes the design idea of fitting between the electrode sheets. By reasonably providing support structures such as concave portions and convex portions in the positive electrode sheet and combining the content of a binder in the positive electrode active material layer, a local micro gap can be formed between the positive electrode sheet and the negative electrode sheet on the basis of ensuring the overall structural strength and structural stability, thereby providing a spatial condition for storing more electrolyte and providing more electrolyte for the long cycle of the battery, and improving the cycle life of the battery. In addition, in the embodiment of this application, by reasonably setting the material ratio of the positive electrode active material layer in the positive electrode sheet, the energy density of the battery can be enhanced, while the positive electrode sheet can further be prevented from being damaged during the formation of the concave-convex area.

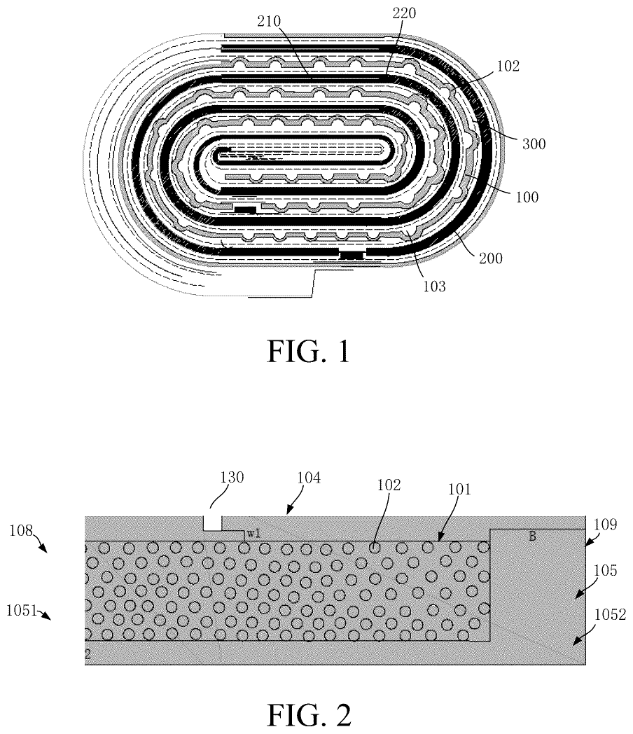

FIG. 1 shows a schematically structural diagram of a battery according to an embodiment of this application.

The embodiment of this application provides a battery. Please referring to FIG. 1, the battery includes a positive electrode sheet 100, a negative electrode sheet 200, and a separator 300; the separator 300 is disposed between the positive electrode sheet 100 and the negative electrode sheet 200; and the separator 300, the positive electrode sheet 100 and the negative electrode sheet 200 are wound in a length direction of the positive electrode sheet 100 to form a rolled-core structure.

The positive electrode sheet 100 in the battery can be selected from the above-mentioned positive electrode sheet 100 provided with the concave portions 103 and the convex portions 102. Meanwhile, the content of the binder in the positive electrode sheet 100 is further optimized. Based on the arrangement of the positive electrode sheet 100, the battery has excellent performance stability, while the energy density and cycle life of the battery can also be improved.

The positive electrode sheet 100 may include a positive electrode current collector 110 and a positive electrode active material. The positive electrode current collector 110 may be an aluminum foil, or other positive electrode current collector 110 commonly used. The thickness of the positive electrode current collector 110 can be set according to actual requirements. In some embodiments, in order to ensure the toughness of the positive electrode sheet 100, the thickness of the positive electrode current collector 110 can be designed in association with the thickness of the positive electrode active material. The positive electrode active material may be coated on one or both surfaces of the positive electrode current collector 110.

The positive electrode active material typically uses lithium-containing compounds. For example, the positive electrode active material may be at least one of lithium cobalt oxide, lithium manganese oxide, lithium iron phosphate, lithium manganese iron phosphate, lithium nickel cobalt manganese oxide, lithium nickel cobalt aluminate, ternary material or lithium nickel manganese oxide. The positive electrode active material further includes a binder and a conductive agent. The binder in the positive electrode active material may include at least one of polyvinylidene fluoride, vinylidene fluoride-hexafluoropropylene copolymer, styrene-acrylate copolymer, styrene-butadiene copolymer, polyamide, polyacrylonitrile, polyacrylic acid ester, polyacrylic acid, polyacrylate, sodium carboxymethyl cellulose, polyvinyl acetate, polyethylene pyrrolidone, polyethylene ether, polymethyl methacrylate, polytetrafluoroethylene or polyhexafluoropropylene. The conductive agent may include at least one of conductive carbon black, acetylene black, Kochen black, flake graphite, graphene, carbon nanotubes or carbon fibers. In some embodiments, based on the total mass of the positive electrode active material layer, the binder has a mass percentage of 1-5 wt %.

The negative electrode sheet 200 may include a negative electrode current collector 210 and a negative electrode active material. The negative electrode current collector 210 may use a copper foil, or other negative electrode current collector 210 commonly used. The thickness of the negative electrode current collector 210 can be provided according to actual requirements. In some embodiments, in order to ensure the toughness of the negative electrode sheet 200, the thickness of the negative electrode current collector 210 can be designed in association with the thickness of the negative electrode active material. The negative electrode active material may be coated on one or both surfaces of the negative electrode current collector 210.

The negative electrode active material may include one of graphite or silicon-based material. The silicon-based material may provide a higher energy density, and includes at least one of silicon, silicon oxide compound, silicon carbon compound or silicon alloy. A conductive agent and/or a binder may further be included. Exemplarily, the conductive agent in the negative electrode active material may include at least one of carbon black, acetylene black, Kochen black, flake graphite, graphene, carbon nanotubes, carbon fibers, or carbon nanowires. The binder in the negative electrode active material may include at least one of carboxymethylcellulose CMC, polyacrylic acid, polyacrylate, polyacrylic acid ester, polyvinylpyrrolidone, polyaniline, polyimide, polyamideimide, polysiloxane, styrene butadiene rubber, epoxy resin, polyester resin, polyurethane resin or polyfluorene.

In the above-mentioned positive electrode sheet 100, the positive electrode active material, and the conductive agent and binder thereof can form an integrate structure and be coated on at least one surface of the positive electrode current collector 110; and for ease of description, the integrate structure may be a positive electrode active material layer 120. In the above-mentioned negative electrode sheet 200, the negative electrode active material, and the conductive agent and binder thereof can form an integrate structure and be coated on at least one surface of the negative electrode current collector 210; and for ease of description, the integrate structure may be a negative electrode active material layer 220.

In some embodiments, the negative electrode sheet 200 includes a negative electrode current collector 210 and a negative electrode active material layer 220, and the negative electrode active material layer 220 may include a silicon-carbon composite material and/or a silicon-oxygen composite material.

The content of silicon element is relatively high in the silicon-carbon composite material and/or the silicon-oxygen composite material. The energy density of the battery can be enhanced by including the silicon-carbon composite material and/or the silicon-oxygen composite in the negative electrode active material layer 220.

The silicon-carbon composite material may include a porous carbon matrix, silicon grains located in pores of the porous carbon matrix, and a carbon layer located on the surface of the porous carbon matrix. The material of the carbon layer may be crystalline carbon or amorphous carbon. In some embodiments, the carbon layer may include openings provided corresponding to the pores of the porous carbon matrix.

By this way, by providing the openings corresponding to the pores of the porous carbon matrix in the carbon layer, the wetting performance of the electrolyte on the negative electrode active material can be improved, and while the expansion performance of the silicon is reduced, improving the cycle life of the battery cell, and enhancing the service life of the battery.

In some embodiments, the material of the negative electrode active layer may further include at least one of artificial graphite, natural graphite, mesophase carbon microspheres, graphene, soft carbon, hard carbon, graphite material coated by soft carbon, and graphite material coated by hard carbon.

In some embodiments, the silicon-carbon composite material has a specific surface area of 0.5 m²/g-10 m²/g. For example, the specific surface area of the silicon-carbon composite may be one of 0.5 m²/g, 0.9 m²/g, 1.3 m²/g, 1.5 m²/g, 1.85 m²/g, 2.0 m²/g, 2.3 m²/g, 2.7 m²/g, 3.2 m²/g, 3.6 m²/g, 3.8 m²/g, 4.6 m²/g, 4.8 m²/g, 5.1 m²/g, 5.4 m²/g, 5.8 m²/g, 6.1 m²/g, 6.5 m²/g, 6.8 m²/g, 7.2 m²/g, 7.5 m²/g, 7.8 m²/g, 8.3 m²/g, 8.9 m²/g, 9.4 m²/g and 9.9 m²/g. Or, the specific surface area of the silicon-carbon composite material may be any value in a range of greater than or equal to 0.5 m²/g and smaller than or equal to 10 m²/g. The specific surface area of the silicon-carbon composite particles can be determined using conventional means in this field, such as TRI STAR II surface area analyzer.

In this way, by controlling the specific surface area of the silicon-carbon composite material, the Solid Electrolyte Interphase (SEI) film can be reduced during the charging process, improving the cycle performance and the service life. It can prevent the SEI film from being too thin due to an excessively small specific surface area of the silicon-carbon composite material, thereby avoiding the situation where the electrolyte and the negative active layer cannot be effectively isolated. Moreover, it can prevent the SEI film from being too thick due to excessively high specific surface area, and can reduce the influence of too thick SEI film on the capacity and efficiency of the battery.

In some embodiments, the silicon-carbon composite material has a particle size Dv50 of 6 μm-15 μm, for example, one of 6 μm, 7 μm, 8 μm, 9 μm, 11 μm, 13 μm, and 14 μm. Or, it may be any value in a range of greater than or equal to 6 μm and smaller than or equal to 15 μm. The particle size Dv50 of the silicon-carbon composite particles can be determined using conventional means in this field, such as a laser particle analyzer.

In this way, by controlling the particle size of the silicon-carbon composite material within the above range, it can avoid the situation where it tends to cause the specific surface of the silicon particles to increase in a case of the particle size being excessively small, thereby increasing side reactions. It can also avoid the problem where it tends to cause the silicon particles to expand excessively in a case of the particle size being excessively large, thereby causing the pores of the porous carbon matrix to be blocked and affecting the wetting of the electrolyte.

The silicon-carbon composite material has an average sphericity of 0.5-1. For example, the average sphericity may be one of 0.6, 0.7, 0.8 and 0.9. Compared to non-spherical particles, as the sphericity is higher, the particle shape is closer to a sphere, resulting in less influence on the structure of the negative electrode sheet during its volume expansion. The overall structural stability of the negative electrode sheet can be maintained during particle expansion. The average sphericity of the silicon-carbon composite particles can be determined using conventional means in this field. For example, using an image processing software (such as IMAGE PRO PLUS), at least ten of the silicon-carbon composite particles are selected in an SEM (scanning electron microscope) image with a certain magnification (such as 2500×), and the circumference and area of each particle are measured to calculate a circumference equivalent radius r1 and an area equivalent radius r2 of each particle, and further to obtain a sphericity r2/r1 of each particle. The average sphericity of the silicon-carbon composite particles is obtained by averaging the sphericity results.

In addition, the spherical particles can improve the mechanical strength and stability of the material, reduce stress concentration between the particles caused by expansion, and thus reduce the risks of mechanical wear and damage of the material during cycling.

In some embodiments, the silicon-carbon composite material has a powder resistivity of 0.1 Ω·cm-1000 Ω·cm. For example, the powder resistivity of the silicon-carbon composite material may be one of 0.1 Ω·cm, 0.9 Ω·cm, 1.2 Ω·cm, 1.3 Ω·cm, 1.8 Ω·cm, 2.7 Ω·cm, 4.6 Ω·cm, 7.85 Ω·cm, 11 Ω·cm, 25 Ω·cm, 38 Ω·cm, 60 Ω·cm, 100 Ω·cm, 200 Ω·cm, 300 Ω·cm, 400 Ω·cm, 500 Ω·cm, 600 Ω·cm, 700 Ω·cm, 800 Ω·cm, 900 Ω·cm and 1000 Ω·cm. Or, the powder resistivity of the silicon-carbon composite material may be any value in a range of greater than or equal to 0.1 Ω·cm and smaller than or equal to 1000 Ω·cm.

In some embodiments, the silicon-carbon composite material may have a silicon content of 30%-75%. For example, the silicon content of the silicon carbon composite may be one of 30%, 35%, 41%, 45%, 49%, 51%, 55%, 59%, 61%, 64%, 71%, and 84%. Or, the silicon content of the silicon-carbon composite material may be any value in a range of greater than or equal to 30% and smaller than or equal to 75%.

In this way, it can avoid excessive expansion of the negative electrode sheet due to the silicon content of the negative electrode active layer being excessively large, thereby leading to deformation of the overall structure of the silicon-carbon particles. Additionally, it can avoid reduction of the energy density of the battery due to the silicon content being excessively small.

In some embodiments, along a thickness direction of the positive electrode sheet 100, the convex portions 102 of the positive electrode sheet 100 have a size h3, and the concave portions 103 of the positive electrode sheet 100 have a size h4, and the h3 and the h4 satisfy a relationship: h3/h4=0.2-1.

Please referring to FIG. 1, in the thickness direction of the positive electrode sheet 100, the convex portion 102 and the concave portion 103 are formed on different sides of the positive electrode sheet 100. The convex portion 102 is arranged corresponding to the concave portion 103. At a certain position of the positive electrode sheet 100, the convex portion 102 is located on one side of the positive electrode sheet 100, and the concave portion 103 is located on the other side of the positive electrode sheet 100. In the above-mentioned embodiment, the size h3 of the convex portions 102 are provided to be smaller than or equal to the size h4 of the concave portions 103. Based on the presence of the concave portions 103, sufficient local micro gaps can be formed between the positive electrode sheet 100 and the negative electrode sheet 200. The smaller size design of the convex portions 102 can further avoid increased size of the battery in the thickness direction, and can provide more storage space for the electrolyte on the basis of ensuring the energy density of the battery, thereby achieving a balance between the energy density and cycle life of the battery. Additionally, the smaller size of the convex portions 102 can prevent the fracture of positive electrode sheet under force due to excessive pressure when the positive electrode sheet 100 forms the convex portions. In a specific design, h3/h4 may be one of 0.2, 0.4, 0.6, 0.8, and 1, or within a range composed of any two thereof.

FIG. 2 shows a schematically structural diagram of a positive electrode sheet [0064] according to an embodiment of this application.

Please referring to FIGS. 1 and 2, the positive electrode sheet 100 includes the above-mentioned positive electrode current collector 110 and the positive electrode active material layer 120 disposed on the surface of the positive electrode current collector 110. The positive electrode active material layer 120 includes the positive electrode active material; the positive electrode active material layer 120 includes a concave-convex area 101 including a plurality of concave portions 103 and convex portions 102 provided corresponding to the concave portions 103. In a nitrogen environment, the positive electrode active material layer 120 has a weight loss rate ρ in a temperature range from 35° C. to 450° C., and the ρ satisfies: 1.1%-6%.

In some specific embodiments, the concave-convex area is formed by stamping the active material layer of the electrode sheet. By stamping the positive electrode active material layer 120 of the positive electrode sheet, the electrode sheet is deformed, thereby enhancing the overall deformation ability of the positive electrode sheet.

It should be noted that the above weight loss rate can be determined by a TGA (Thermogravimetric Analysis) testing. When performing the TGA testing, some materials will undergo thermal carbonization and decomposition, resulting in a mass loss of the positive electrode sheet 100, thereby causing the above-mentioned weight loss phenomenon. The weight loss rate indicates the proportion of the mass reduction of the positive electrode sheet 100 in amount during the high-temperature test.

In the above-mentioned embodiment, the weight loss rate of the positive electrode sheet is provided in the above-mentioned range, and the weight loss rate is used to indicate the structural stability of the positive electrode sheet. The weight loss rate is affected by the factors such as the compaction density of the positive electrode sheet, the height of the convex portions and the content of the binder. By controlling the weight loss rate, it prevents problems such as elongation of the binder in the positive electrode active material layer due to excessive pressure to form the concave-convex area during the formation of the concave-convex area in the positive electrode sheet, which reduces the effect of the binder in connecting the positive electrode active particles; or excessive compaction density during the rolling process; or power falling-off due to excessive force received by the positive electrode active material layer that is caused by the content of the binder in the positive electrode active material layer being too low. In addition, excessive content of the binder can not only affect the energy density of the positive electrode sheet, but also cause the overall structure of the positive electrode sheet with larger weight loss rate to become brittle and hard and have poor overall toughness, resulting in that the positive electrode sheet is not ductile as a whole and thus is easily crushed due to excessive stress concentration during the formation of the concave-convex area. That is, by balancing the compaction density of the positive electrode sheet, the content of the binder, and the height of the convex portions to control the weight loss rate of the positive electrode sheet within this range, it can prevent the positive electrode sheet from being damaged during the formation of the concave-convex area on the basis of ensuring the energy density.

In a specific design, the weight loss rate ρ may be 1.1%, 1%, 2%, 3%, 4%, 5%, and 6%, or within a range composed of any two thereof.

In the embodiment of this application, since the positive electrode active material layer 120 is provided with the concave-convex area 101, a local micro gap can be formed between the positive electrode sheet 100 and the negative electrode sheet 200, thereby providing a spatial condition for storing more electrolyte, providing more electrolyte for long cycles of the battery, improving the wetting ability of the electrolyte in this area, and avoiding the occurrence of abnormal situations such as electrolyte shortage and poor wetting between the positive electrode and the separator. Accordingly, the cycle life of the battery is improved. Furthermore, by the formation of the concave-convex area, the surface of the positive electrode sheet is rough, so that when the battery cell expands, the convex portions can effectively support the separator, preventing the separator from being deformed by the expansion stress of the negative electrode sheet.

In addition, the positive electrode sheet is provided with the convex portions to improve the deformation ability of the positive electrode sheet. When the positive electrode sheet comes into contact with the expanded negative electrode sheet, the expansion stress of the negative electrode sheet can be effectively absorbed by the convex portions of the positive electrode sheet, and the expansion of the negative electrode sheet can be buffered during the cycle process of the battery, avoiding cracks caused by excessive expansion stress of the negative electrode sheet. Moreover, part of the expansion stress of the negative electrode sheet can be absorbed by the convex portions provided in the positive electrode sheet, allowing the negative electrode sheet not to rely entirely on the resistance of its own material during expansion. This delays the fatigue of the negative electrode material, thereby enhancing the service life of the negative electrode sheet.

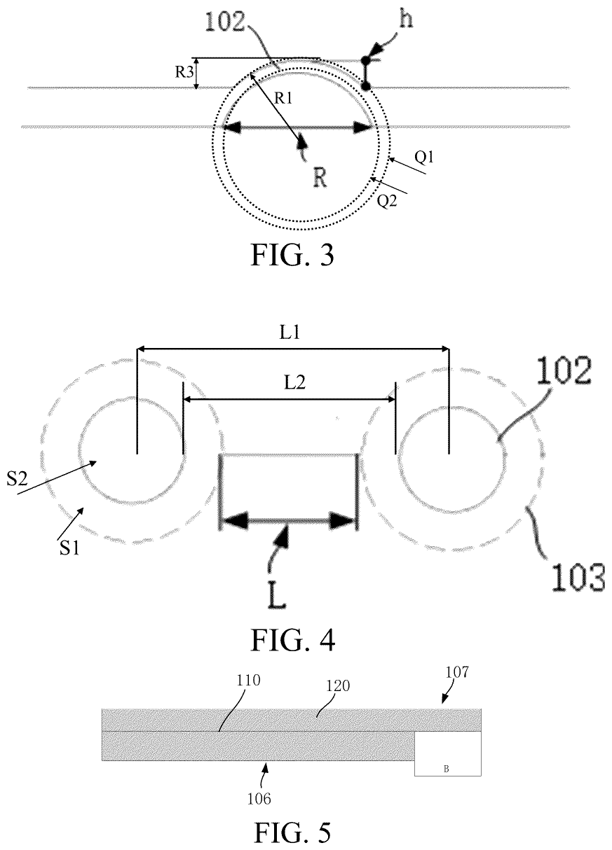

FIG. 3 shows a schematically structural diagram of a convex portion according to an embodiment of this application. FIG. 4 shows a schematically structural diagram of two adjacent convex portions of a positive electrode sheet according to an embodiment of this application.

In some embodiments, please referring to FIG. 3, the height of the top of the convex portions 102 from the surface of the positive electrode active material layer 120 is h, and the h and the ρ satisfy a relationship: 50<h/ρ<3600, and/or h=3 μm-40 μm.

It can be understood that the larger size h, that is, the higher top of the convex portions, means the greater stress received by the positive electrode sheet during the formation of the convex portions 102, that is, the higher probability of the positive electrode active material in the positive electrode sheet being subjected to powder loss under force. Additionally, in a case of the higher top of the convex portions, the positive electrode active material of the top of the convex portions is more prone to cracking or falling off, and this makes it easier for the positive electrode active material to come into contact with the negative electrode sheet through the separator, resulting in self-discharging. At this moment, a good combination relationship can be formed by combining with the weight loss rate (i.e. the content of the binder). That is, the structural stability of the convex portions 102 can be ensured, thereby preventing the problems such as powder loss from the positive electrode active material layer or fracture of the positive electrode piece, avoiding detachment of the positive electrode active material in the top, and further preventing poor toughness of the positive electrode sheet caused by excessive content of the binder, which is prone to fracturing under compression. And it is possible to avoid severe expansion of the silicon-doped negative electrode sheet during the charging-discharging process, which results in squeezing the convex portions of the positive electrode sheet such that the convex portions undergo collapse and deformation, and avoid affecting the energy density. In a specific design, h/p may be 50, 200, 400, 600, 800, 1200, 1400, 1600, 1800, 2400, 3000, 3200, 3400, 3600 or within a range composed of any two thereof; and h may be 3 μm, 10 μm, 20 μm, 30 μm, 40 μm, or within a range composed of any two thereof.

In some embodiments, please referring to FIG. 4, the convex portions 102 has a diameter R, a distance between the two adjacent convex portions 102 is L, and the R, the L, and the ρ satisfy a relationship: 10<L/R/ρ<1000, and/or R=1000 μm-5000 μm, and/or L=1500 μm-5000 μm.

It can be understood that the L/R can reflect the dense degree of the convex portions 102 of the positive electrode current collector 110. This dense degree is related to the value of the weight loss rate. The greater dense degree indicates the more convex portions 102, which is more conducive to the wetting of the electrolyte and the improvement of the cycle life. However, if the L/R is excessively large, that is the convex portions are excessively dense, it can easily lead to excessive stress concentration during the formation of the convex portions 102, making it difficult to effectively release the stress and allowing the positive electrode active material layer of the positive electrode sheet 100 to be more prone to powder loss, even fracture of the positive electrode sheet, which imposes higher demands on the toughness of the positive electrode sheet. Herein, providing the L/R/p within the above-mentioned range helps is beneficial to achieve a balance between the dense degree and the weight loss rate. The ratio of the dense degree of the embossed concave portions to the weight loss rate is controlled, that is, the dense degree of the embossed convex portions is controlled, so as to ensure the energy density. Meanwhile when the concave portions or the convex portions of the positive electrode are subjected to force, the convex portions within this ratio range can effectively disperse the stress received by the convex portions, thereby preventing the occurrence of cracks or powder loss. In a specific design, the L/R/p may be 10, 100, 200, 300, 400, 500, 600, 700, 800, 900, 1000, or within a range composed of any two thereof; R may be 1000 μm, 2000 μm, 3000 μm, 4000 μm, 5000 μm or within a range composed of any two thereof; and L may be 1500 μm, 2000 μm, 3000 μm, 4000 μm, 5000 μm or within a range composed of any two thereof.

In some embodiments, the positive electrode sheet 100 has a compaction density D; and the D, the h, and the R satisfy a relationship: 0.004<D*h/R<0.12, and/or D=3 g/cm³-4.5 g/cm³.

It should be noted that the compaction density D of the positive electrode sheet 100=(a mass of the positive electrode sheet−a mass of the positive electrode current collector)/[a surface area of the positive electrode sheet (single-side area)*(a thickness of the positive electrode sheet−a thickness of the positive electrode current collector)].

The compaction density of the positive electrode sheet 100 indicates the tightness degree of the particles in the positive electrode active material layer 120, and the h/R can reflect the size of the above particles. The larger the compaction density of the positive electrode sheet, the closer the bonding of the active material. With the same size for embossing, the height of the convex portions decreases with the increase of the compaction density. Continuing to increase the height of the convex portions leads to a risk of fracture to the positive electrode sheet. By seeking a balance between the compaction density and the size of the particles, the structural stability of the positive electrode sheet 100 can be improved, which facilitates the formation of the above-mentioned concave-convex area 101 in the positive electrode sheet 100, and can prevent the positive electrode sheet 100 from fracturing. In a specific design, the D*h/R may be 0.004, 0.008, 0.012, 0.016, 0.036, 0.056, 0.076, 0.1, 0.12, or within a range composed of any two thereof; and the D may be 3 g/cm³, 3.5 g/cm³, 4 g/cm³, 4.5 g/cm³, or within a range composed of any two thereof.

In some embodiments, the number of the convex portions 102 or the concave portions 103 in a unit area of the concave-convex area 101 is N per cm², and the N=2-25, preferably, the N=4-15.

The value of the N can reflect the dense degree of the convex portions 102. By providing the N in the above-mentioned range, the cycle life and energy density of the battery can be reasonably balanced, and meanwhile, the structural stability of the positive electrode sheet 100 can be ensured, which can prevent the convex portions from being excessively dense and avoid the positive electrode sheet 100 from breakage due to excessive force during the formation of the convex portions.

In some embodiments, the positive electrode active material layer includes a conductive agent, the conductive agent includes single-walled carbon nanotubes extending into the positive electrode active material at the top of the convex portions 102.

It can be understood that after the formation of the convex portions 102, the gap between the particles at the top of the convex portions 102 is larger than that between the particles at other positions of the convex portions 102. By providing the conductive agent including the single-walled carbon nanotubes, the single-walled carbon nanotubes are connected linearly to adjacent positive electrode active material. Moreover, during the embossing process, the single-walled carbon nanotubes can adapt to stress by undergoing tensile deformation, and always maintain their connection to the adjacent positive electrode active material. This can ensure the conductive performance of the particles at the top of the convex portions 102.

In some specific embodiments, the single-walled carbon nanotubes are interwoven to form a mesh structure, and the positive electrode active material at the top of the convex portions 102 is wrapped within the mesh structure.

By setting the single-walled carbon nanotubes into the mesh structure, it is beneficial to achieve better contact between the particles and the single-walled carbon nanotubes, and it can also increase the contact area between the particles and the single-walled carbon nanotubes, thereby improving the conductive performance between the particles at the top of the convex portions 102.

In some specific embodiments, the single-walled carbon nanotubes have a diameter of 1 nm-1000 nm and a length of 1 μm-100 μm; and/or based on a total mass of the positive electrode active material layer 120, the single-walled carbon nanotubes have a mass percentage of 0.5%-5%; and/or the single-walled carbon nanotubes in the positive electrode active material layer 120 have a thickness of 10 nm-500 nm.

In the above-mentioned embodiment, the content and size of the single-walled carbon nanotubes in the positive electrode active material layer 120 can be defined in terms of diameter, length, mass percentage and thickness. By providing the diameter, length, mass percentage and thickness of the single-walled carbon nanotubes in the above-mentioned range, the positive electrode sheet 100 in the above-mentioned embodiment can be better matched, so that the basic properties of the positive electrode sheet 100 can be ensured under a condition that the conductive performance between the particles at the top of the convex portions 102 is enhanced. The basic properties here include the structural stability, cycle life, energy density, etc. as mentioned above.

In a specific design, the diameter of the single-walled carbon nanotubes may be 1 nm, 100 nm, 500 nm, 1000 nm or within a range composed of any two thereof; the length of the single-walled carbon nanotubes may be 1 μm, 10 μm, 30 μm, 50 μm, 70 μm, 90 μm, 100 μm or within a range composed of any two thereof; the mass percentage of the single-walled carbon nanotubes may be 0.5%, 1%, 1.5%, 2%, 2.5%, 3%, 4%, 5%; the thickness of the single-walled carbon nanotubes may be 10 nm, 200 nm, 300 nm, 400 nm, 500 nm or within a range composed of any two thereof.

In some embodiments, two adjacent convex portions 102 form a first projection and a second projection respectively, the first projection has a first circumscribed circle, and the second projection has a second circumscribed circle; a distance between a center of the first circumscribed circle and a center of the second circumscribed circle is L1, a distance between the first projection and the second projection is L2; and the L1 and the L2 satisfy a relationship: L1/L2=1.05-3, preferably, L1/L2=1.1-2.

The L1/L2 can reflect the dense degree of the convex portions 102. By providing the L1/L2 in the above-mentioned range, a suitable distance can be formed between the convex portions 102, ensuring the wetting effect of the electrolyte, and then ensuring the cycle life of the battery, and also preventing the positive electrode sheet 100 from fracturing.

In a specific design, the L1/L2 may be 1.05, 1.1, 1.3, 1.5, 1.7, 2, 2.5, 3, or within a range composed of any two thereof.

In some specific embodiments, L1=3 mm-10 mm, preferably L1=2 mm-8 mm; and/or L2=0.5 mm-8 mm, preferably L2=1 mm-4 mm.

When the distance between the convex portion 102 and the convex portion 102 is smaller than 2 mm, the protrusions of a processing roller are too densely arranged. In this case, the extension of the positive electrode sheet 100 cannot satisfy the high dense degree of the convex portions 102, and the height of the convex portions 102; and the positive electrode sheet 100 has less space for deformation, and the positive electrode sheet 100 is prone to cracking. When the distance between the convex portion 102 and the convex portion 102 is greater than 8 mm, the protrusions of the processing roller are too sparsely arranged. In this case, the convex portions 102 are too dispersed, and the supporting area for the convex portions 102 is insufficient, thereby not achieving the wetting effect of the electrolyte. In the embodiment of this application, by defining the ratio of the L1 and L2, the dense degree of the convex points can be ensured, thereby providing sufficient support for the electrode sheet, so that the positive electrode sheet 100 has sufficient deformation space to alleviate the expansion of the negative electrode sheet 200.

In some embodiments, the convex portion 102 have a circumscribed ball, the circumscribed ball includes an outer surface, and a flat area is formed between two adjacent convex portions 102; the outer surface has a spherical radius R1, a distance between the top of the convex portions 102 and the flat area is R3, and the R1 and R3 satisfy a relationship: R3<R1, preferably, R3<1/5R1.

The circumscribed ball is an ideal shape of the convex portions 102. It can be understood that when the positive electrode sheet 100 is processed to form the concave-convex area 101, the convex portions 102 generally do not exhibit an absolute regular shape similar to the above-mentioned circumscribed ball based on the factors such as processing method, process and error. For example, during the formation of the convex portions 102 by rolling, the convex portions 102 will be squeezed during the rolling process, resulting in deformation or extension of the electrode sheet, so that the convex portions 102 will be relatively flattened partially, thereby causing R3<R1. In the above-mentioned embodiment, the process can be simplified by controlling R3<1/5R1, and at the same time, the basic properties of the positive electrode sheet 100 can be ensured after the formation of the concave-convex area 101.

In some embodiments, the outer surface has a surface area Q1, and a projection of the outer surface formed on the positive electrode current collector 110 along a thickness direction of the electrode sheet has an area S1; the circumscribed ball further includes an inner surface, the inner surface has a surface area Q2, and a projection of the inner surface formed on the positive electrode current collector 110 along the thickness direction of the electrode sheet has an area S2; and the Q1 and Q2 satisfy: Q1/Q2=1.02-1.21, and/or the S1 and S2 satisfy: S1/S2=1.02-1.21.

The volume of the convex portions 102 can be properly controlled by providing the above-mentioned relationship, thereby facilitating a balance between the cycle performance and energy density and the structural stability of the positive electrode sheet 100, providing space for expansion of the negative electrode sheet 200, and preventing adverse consequences such as fracture of the negative electrode sheet 200. In a specific design, the Q1/Q2 may be 1.02, 1.05, 1.07, 1.12, 1.15, 1.19, 1.21, or within a range composed of any two thereof, and the S1/S2 may be 1.02, 1.05, 1.07, 1.12, 1.15, 1.19, 1.21, or within a range composed of any two thereof.

In some embodiments, an area sum of projection of each of the convex portions 102 on the positive electrode current collector 110 is S11, and an area of the positive electrode sheet 100 is S, and the S11 and S satisfy a relationship: 0.02≤S11/S≤0.85.

The S11/S can reflect the dense degree of the convex portions 102 of the positive electrode current collector 110. When the S11/S value is small, the number of the convex portions 102 is small, making it difficult to achieve the purpose of improving the cycle life and energy density. When the S11/S value is large, the number of the convex portions 102 is large, easily causing wrinkle, deformation, and even fracture of the positive electrode sheet 100. In the above-mentioned embodiment, by providing the S11/S in the above-mentioned range, it is beneficial to prevent the positive electrode sheet 100 from being damaged on the basis of improving the cycle life and energy density. In a specific design, the S11/S may be 0.02, 0.04, 0.1, 0.2, 0.32, 0.4, 0.5, 0.6, 0.7, 0.85, or within a range composed of any two thereof.

In some embodiments, please referring to FIG. 2, the positive electrode active material layer 120 further includes a tab area 104 and an end avoidance zone 105. The tab area 104 is located at least one side of the concave-convex area 101 in a width direction of the positive electrode sheet 100, and a positive electrode tab 130 is arranged on the tab area 104. The end avoidance zone 105 is located on one side of the concave-convex area 101 in the length direction of the positive electrode sheet 100.

In combination with the above description, the concave-convex area 101 is an area provided with the convex portions 102 and the concave portions 103. Herein, by providing the tab area 104 on one side of the concave-convex area 101, a stable installation environment can be provided for the positive electrode tab 130, which is conducive to reducing the installation difficulty and process of the positive electrode tab 130, improving the installation stability of the positive electrode tab 130, and preventing the interface deterioration of the region around the positive electrode tab 130 due to the interaction between the positive electrode tab 130 and the positive electrode sheet 100, thereby simplifying the installation of the tab on the basis of avoiding the problems such as poor wetting, interface deterioration, cycling failure and lithium precipitation.

In some embodiments, the tab area 104 has a width W2, and the W2 satisfies: 1 mm≤W2≤30 mm.

The tab area 104 is located at the edge of the positive electrode sheet 100 in the width direction, and this W2 can indicate the proportion of the tab area 104 in the width direction of the positive electrode sheet 100. In a specific design, the W2 may be 1 mm, 5 mm, 10 mm, 15 mm, 20 mm, 25 mm, 30 mm, or within a range composed of any two thereof. It can be understood that the tab area 104 is an area where no convex portions 102 or concave portions 103 are provided. In a case of the W2 exceeding 30 mm, the width of the tab area 104 is large enough; although the tab area 104 is conducive for the installation of the positive electrode tab 130, correspondingly, the convex portions 102 account for a smaller proportion relative to the positive electrode sheet 100, which will lead to insufficient electrolyte storage in the tab area 104, easily causing the problems such as poor wetting, and even lithium precipitation. In a case of the W2 being smaller than 1 mm, abnormal structures such as bending, rough, and wavy edges may occur at the edges of the positive electrode sheet 100 in the width direction, which is not conducive to correcting the positive electrode sheet 100 by laser during the production process, and may lead to the problem of bad coverage of the positive electrode sheet 100 by the negative electrode sheet 200. Therefore, by providing the W2 within the above-mentioned size range in the embodiment of this application, the abnormal structures formed at the edges of the positive electrode sheet 100 can be controlled, and the wetting of the electrolyte can be ensured.

The tab area 104 is provided with a tab, and a distance between the tab and the concave-concave area 101 in the width direction is W1, and the W1 satisfies: 1 mm≤W1≤5 mm.

In a specific design, the W1 may be 1 mm, 2 mm, 3 mm, 4 mm, 5 mm, or within a range composed of any two thereof. It can be understood that in a case of W1 exceeding 5 mm, the space between the convex portions 102 and the tab is large, which can facilitate the installation of the positive electrode tab 130, but affect the number of the convex portions 102, thereby affecting the above-mentioned basic properties of the positive electrode sheet 100. This is not conducive to the wetting of the electrolyte, and is also not conducive to avoiding lithium precipitation. In a case of W1 being smaller than 1 mm, the space between the convex portions 102 and the positive electrode tab 130 is smaller, which increases the installation difficulty of the positive electrode tab 130; and which also increases the number of the convex portions 102, facilitating the wetting of the electrolyte and avoiding lithium precipitation. Therefore, by providing the W1 within the above-mentioned size range in the embodiment of this application, the basic properties of the positive electrode sheet 100 can be ensured on the basis of simplifying the installation of the positive electrode tab 130.

The end avoidance zone 105 is a structure corresponding to the single-sided area 107 on the positive electrode sheet 100. The single-sided area 107 here refers to the position where the positive electrode active material layer 120 is provided on one side of the positive electrode current collector 110 while the positive electrode active material layer 120 is not provided on the other side.

FIG. 5 shows a side view of a positive electrode sheet 100 according to an embodiment of this application.

Combining FIG. 2 and FIG. 5, the positive electrode sheet 100 includes a double-sided area 106 and a single-sided area 107 along the length direction. The double-sided area 106 indicates that the positive electrode active material layer 120 is provided on both sides of the positive electrode current collector 110 of the positive electrode sheet 100, and the single-sided area 107 is provided with the positive electrode active material layer 120 only on one side of the positive electrode current collector 110, and the concave-convex area 101 is formed in the double-sided area 106.

In some embodiments, a head end 108 and a tail end 109 are formed along the length direction of the positive electrode sheet 100. The end avoidance zone 105 includes a first avoidance zone 1051 located at the head end 108 and a second avoidance zone 1052 located at the tail end 109. The size of the first avoidance zone 1051 along the length direction is A, and the size of the second avoidance zone 1052 along the length direction is B; the A satisfies: 1 mm≤A≤5 mm, and the B satisfies: 100 mm≤B≤800 mm.

In a specific design, A may be 1 mm, 2 mm, 3 mm, 4 mm, 5 mm, or within a range composed of any two thereof. It can be understood that in a case of the A exceeding 5 mm, it can improve the structural stability of the inner region of the rolled-core structure, but it is not conducive to wetting; in a case of the A being smaller than 1 mm, it can reduce the structural stability of the inner region of the rolled-core structure, but increase the wetting amount. Therefore, by providing the A within the above-mentioned size range, the balance between the structural stability of the inner region of the rolled-core structure and the wetting amount can be achieved in the embodiment of this application.

In a specific design, the B may be 100 mm, 200 mm, 300 mm, 400 mm, 500 mm, 600 mm, 700 mm, 800 mm, or within a range composed of any two thereof. In a case of the size B of the second avoidance zone 1052 being within the range of 100 mm-800 mm, the second avoidance zone 1052 has an appropriate length for finishing, improving the connection stability of the outside of the rolled-core structure. Thus, the entire battery has good winding stability, and the convex portions 102 near the outer rings have an appropriate distribution range, thereby providing support for the winding units in the outer rings and alleviating the squeeze problem of the outer rings of the rolled-core structure. In a case of the B being smaller than the lower limit of 100 mm, the second avoidance zone 1052 becomes too small in size, and the distance between the convex portions 102 and the edge of the entire electrode sheet in the length direction of the entire electrode sheet is too small, making it difficult to improve the encapsulating stability at the finishing end of the rolled-core structure. In a case of the B being greater than the upper limit of 500 mm, the second avoidance zone 1052 is too large in size and occupies too large area, resulting in insufficient distribution areas for the convex portions 102. This leads to poor support effect of the convex portions 102, making it difficult to improve the wetting effect of the electrolyte.

The batteries and applications thereof provided by this application will be described in detail below through specific examples.

Without special description, the reagents, materials and instruments used in the following examples are conventional reagents, conventional materials and conventional instruments in the art, and can be obtained commercially; and the reagents involved can also be synthesized by conventional methods in the art.

This application will be further illustrated below by taking the electrode assembly of a lithium-ion battery as an example and combining with specific examples. It should be understood that these examples are for illustration only and not for limiting the scope of this application.

In each example and comparative example of this application, the following method is used to prepare lithium-ion batteries and test the performance of the lithium-ion batteries.

### I. Preparation Method of the Lithium-Ion Battery

### 1. Preparation of the Positive Electrode Sheet 100

(lithium cobalt oxide+Li₂NiO₂), conductive carbon black (SP), and polyvinylidene difluoride (PVDF) are mixed according to a mass ratio of 97 (where the weight of the Li₂NiO₂ accounts for 1% of the weight of the lithium cobalt oxide):1:2, N methylpyrrolidone (NMP) is added, followed by stirring evenly to prepare a positive electrode slurry. The positive electrode slurry is coated on the front and back surfaces of an aluminum foil, and a positive electrode sheet 100 with a thickness of 100 μm is obtained after baking and rolling. The positive electrode sheet 100 is embossed from an A-side to a C-side through a roller to obtain circular convex portions 102, where the convex portions 102 have a diameter R of 2000 μm, the distance L between a convex portion 102 and a convex portion 102 is 2000 μm, and the height h of the top of the convex portions 102 from the surface of the positive electrode active material layer 120 is 20 μm.

### 2. Preparation of the Negative Electrode Sheet 200

A negative electrode active material doped with silicon-carbon is mixed with conductive carbon black (SP), carboxymethylcellulose lithium (CMC-Li), and polyacrylic acid (PAA) according to a mass ratio of 97 (where the weight of silicon-carbon accounts for 5% of the weight of graphite): 0.4:0.1:2.5, and deionized water is added to prepare a negative electrode slurry. The negative electrode slurry is coated on the front and back surfaces of a carbon-coated copper foil, and a negative electrode sheet 200 with a thickness of 110 μm is obtained after baking and rolling. The negative electrode sheet 200 is provided with a fixed-size slot at a certain position, and a nickel-plated copper tab is welded in this slot by laser or ultrasonic welding.

### 3. Preparation of a Rolled-Core Structure

The positive electrode sheet 100 and the negative electrode sheet 200 are subjected to cutting, film production and then winding with a separator 300 to form the rolled-core structure.

### 4. Battery Assembling

The rolled-core structure is subjected to encapsulating, baking, electrolyte injection, formation, second encapsulating, sorting and OCV (Open Circuit Voltage) tested to obtain a battery. The electrolyte injected for the electrolyte injection may be a conventional electrolyte, and the lithium salt is LiFP6.

### II. Performance Test of Lithium-Ion Batteries

### 1. K Value

After the battery is stored in a high-temperature room at 45° C. for 48-60 h, the battery is removed and left to stand in a constant-temperature room at 25° C. for 24 h, and the battery voltage V1 is tested; the battery is left to stand in a constant-temperature room at 25° C. for 72-96 h, and the battery voltage V2 is tested; the voltage drop is (V1−V2)/the interval time between the two tests.

### 2. Cycle Life at 25° C.

In an environment of 25° C., the electrode assembly is constant-current charged to a full-charge voltage at a charging current of 2 C/5 C (the battery is designed to have a maximum voltage of 4.5V), and then is constant-voltage charged at the maximum voltage until the current is 0.02 C, and then is constant-current discharged at a discharge current of 0.5 C until the final voltage is 3.0V, in which the discharge capacity for the first cycle is recorded. Then, the above steps are repeated for the charging and discharging cycles, and the number of cycles N when the cycle capacity retention rate begins to be smaller than or equal to 80% is recorded.

$$Cycle capacity retention rate = ( discharge capacity of the Nth cycle / discharge capacity of the first cycle ) \times 100 \% .$$

### 3. Expansion Rate for 1000 T Cycles at 25° C.

The battery is stored in a constant-temperature room or constant-temperature box at 25° C. for 2 h, is constant-current charged to the upper-limit voltage at 1 C, and cut off at 0.05 C to record a cell thickness h1; the battery is left to stand for 10 min, then discharged at 0.5 C to 3.0V; the above steps are cycled for 1000 T; then the battery is constant-current charged to the upper-limit voltage at 1 C, and cut off at 0.05 C to record a cell thickness h2 at this moment. The h2/h1 is the expansion rate for 1000 T cycles at 25° C.

### 4. Fracture Probability of the Electrode Sheet

In a constant-temperature room at 45° C., the battery is constant-current and constant-voltage charged to the upper-limit voltage at 1 C, and cut off at 0.05 C; then is left to stand for 10 min, and discharged at 0.5 C to 3.0V; and is disassembled 10 pcs after 600 T cycles to count the number of fractured electrode sheets.

Table 1 shows various parameters of Examples 1-5 and Comparative Example 1-3; and Table 2 shows the experimental results.

TABLE 1

| Example | h | ρ | h/ρ | R | L | L/R | L/R/ρ | D | D*h/R |
|---|---|---|---|---|---|---|---|---|---|
| Example 1 | 20 | 2% | 1000 | 2000 | 2000 | 1 | 50 | 4 | 0.04 |
| Comparative | 20 | 1% | 2000 | 2000 | 2000 | 1 | 100 | 4 | 0.04 |
| Example 1 | | | | | | | | | |
| Comparative | 20 | 10% | 200 | 2000 | 2000 | 1 | 10 | 4 | 0.04 |
| Example 2 | | | | | | | | | |
| Example 2 | 3 | 6% | 50 | 2000 | 2000 | 1 | 16.66667 | 4 | 0.006 |
| Comparative | 40 | 1.1% | 3636.364 | 3000 | 2000 | 0.666667 | 60.60606 | 4 | 0.053333 |
| Example 3 | | | | | | | | | |
| Example 3 | 5 | 1.1% | 454.5455 | 1000 | 3000 | 3 | 272.7273 | 4 | 0.02 |
| Example 4 | 40 | 2% | 2000 | 1000 | 2000 | 2 | 100 | 3 | 0.12 |
| Example 5 | 3 | 2% | 150 | 3000 | 2000 | 0.666667 | 33.33333 | 4.5 | 0.0045 |

TABLE 2

| | | K | Fracture | Cycle |
|---|---|---|---|---|
| Example | Results | Value | probability | life |
| Example 1 | No powder loss, good toughness, and | 0.005 | 0% | 1500T |
| | good electrolyte retention | | | |
| Comparative | Powder loss | 0.01 | 0% | 1200T |
| Example 1 | | | | |
| Comparative | High binder content, poor toughness, | 0.01 | 100% | 1000T |
| Example 2 | and fracture of embossed electrode | | | |
| | sheet | | | |
| Example 2 | Small depth of embossing, and poor | 0.008 | 80% | 1250T |
| | electrolyte retention | | | |
| Comparative | Large depth of embossing, and | 0.01 | 100% | 1300T |
| Example 3 | fracture of aluminum layer | | | |
| Example 3 | Sparse embossing, and worse | 0.005 | 20% | 1200T |
| | electrolyte retention performance than | | | |
| | that of Example 1 | | | |
| Example 4 | Small compaction, and good toughness | 0.01 | 10% | 1200T |
| Example 5 | Large compaction, and poor toughness | 0.008 | 50% | 1200T |

The following conclusions are drawn by analyzing Tables 1-4.

1) By comparing Example 1, Comparative Example 1 and Comparative Example 2, it can be seen that the structural stability of the positive electrode sheet can be changed by changing the weight loss rate. When the weight loss rate is small, the positive electrode sheet has poor structural stability and is prone to powder loss. When the weight loss rate is large, the positive electrode sheet has high brittleness and is prone to fracture. Maintaining the weight loss rate between 1.1% and 6% can ensure the structural stability of the positive electrode sheet, prevent powder loss and other problems of the positive electrode sheet, and prevent damage of the positive electrode sheet during the formation of the concave-convex area on the basis of ensuring the energy density.

By comparing Example 2 and Comparative Example 3, it can be seen that when the h/p is too small, the height of the convex portions is small, the storage space for the electrolyte is small, and the content of the electrolyte is small, which affect the service life of the battery.

2) When the h/p is too large, the content of the binder in the positive electrode material is low at this moment, and the positive electrode paste is prone to falling off, affecting the service life of the battery cell. At the same time, the height of the convex portions is too large, the squeeze stress on the positive electrode sheet is high, and the positive electrode sheet is more likely to fracture.

By comparing Examples 1-5 and Comparative Examples 1-3, it can be seen that the L/R/ρ is provided to satisfy: 10<L/R/ρ<1000. When the L/R/ρ is too small and the content of the binder is high, the positive electrode sheet becomes brittle and the flexibility of the electrode sheet is reduced. In such cases, embossing is prone to cause fracture of the positive electrode sheet. When the L/R/ρ is too large, the embossing regions are sparse, leading to reduced electrolyte retention capacity and a decrease in electrolyte content, which significantly shortens the service life of the battery cell. When the condition 10<L/R/ρ<1000 is satisfied, the battery has a long service life without the fracture risk of the electrode sheet, ensuring safety performance of the battery.

By comparing Examples 1-5 and Comparative Examples 1-3, it can be seen that the D*h/R is provided to satisfy: 0.004<D*h/R<0.12. When the D*h/R is too large, the compaction of the positive electrode sheet becomes larger, resulting in poor flexibility of the electrode sheet. The greater height of the convex portions facilitates the electrode sheet to fracture. When the D*h/R is too small, the compaction of the positive electrode sheet is small, which is unfavorable for improving the overall energy density of the battery cell. Additionally, the smaller height of the convex portions leads to poor electrolyte retention capacity, affecting the service life of the battery. When the condition 0.004<D*h/R<0.12 is satisfied, the overall battery has high energy density while maintaining a long service life.

In the description of this application, it should be understood that the terms “including”, “having” and any variant thereof used in the embodiments of this application are intended to cover non-exclusive inclusions. For example, processes, methods, systems, products or devices that contain a series of steps or units are not limited to those steps or units clearly listed, but may include other steps or units not clearly listed or inherent to these processes, methods, products or devices.

Unless otherwise specified and defined, the terms such as “installed”, “connected”, “connecting”, “fixed” should be broadly understood. For example, they can be connected fixedly, connected detachably, or integrated; they can be directly connected, or indirectly connected through an intermediate media; it may be a connection within two elements or an interaction between the two elements. For those skilled in the art, the specific meaning of the above terms in this application can be understood in accordance with the specific circumstances. Furthermore, the terms such as “first”, “second” are for descriptive purposes only and should not be understood as indicating or implying relative importance or implying the number of technical features indicated.

Finally, it should be noted that the above embodiments are only used to illustrate, rather than to limit, the technical solutions of this application. Although this application has been described in detail with reference to the above embodiments, those ordinarily skilled in the art should understand that the technical solutions described in the above embodiments can still be amended, or some or all of the technical features thereof can be replaced equivalently. However, such amendments or replacements do not make the essence of the corresponding technical solutions deviate from the scope of the technical solutions in the embodiments of the present application.

1. A battery, comprising a separator, a negative electrode sheet and a positive electrode sheet, wherein the separator is disposed between the positive electrode sheet and the negative electrode sheet, and the separator, the positive electrode sheet and the negative electrode sheet are wound in a length direction of the positive electrode sheet to form a rolled-core structure;
the positive electrode sheet comprises a positive electrode current collector and a positive electrode active material layer disposed on a surface of the positive electrode current collector, wherein the positive electrode active material layer comprises a positive electrode active material;
the positive electrode active material layer comprises a concave-convex area, and the concave-convex area comprises a plurality of concave portions and convex portions disposed respectively corresponding to the concave portions;
in a nitrogen environment, the positive electrode active material layer has a weight loss ratio ρ in a temperature range from 35° C. to 450° C., and the ρ satisfies:
$$0. 011 < ρ < 0.06 ;$$
wherein a height between a top of the convex portions and a surface of the positive electrode active material layer is h, and the h and the ρ satisfy a relationship:
50<h/ρ<2000, wherein the h is in μm;
wherein the concave portions have a diameter of R, and a distance between two adjacent concave portions is L, and the R, the L, and the ρ satisfy a relationship:
10<L/R/ρ<1000; wherein the R and the L are in μm;
wherein R=1000 μm-5000 μm, and L=1500 μm-5000 μm;
wherein the positive electrode sheet has a compaction density D, and the D, the h, and the R satisfy a relationship:
0.004<D*h/R<0.12; wherein the D is in g/cm³;
wherein the positive electrode active material layer comprises a binder, and based on a total mass of the positive electrode active material layer, the binder has a mass percentage of 1 wt %-5 wt %.

2. The battery according to claim 1, wherein h=3 μm-40 μm.

3. (canceled)

4. The battery according to claim 1, wherein D=3 g/cm³-4.5 g/cm³.

5. The battery according to claim 1, wherein the convex portions or the concave portions in the concave-convex area per unit area is N per cm² in number, and the
$$N = 2 - 25.$$

6. The battery according to claim 1, wherein the positive electrode active material layer comprises a conductive agent, and the conductive agent comprises single-walled carbon nanotubes.

7. The battery according to claim 1, wherein two adjacent convex portions form a first projection and a second projection respectively, the first projection has a first circumscribed circle, and the second projection has a second circumscribed circle; a distance between a center of the first circumscribed circle and a center of the second circumscribed circle is L1, a distance between the first projection and the second projection is L2, and the L1 and the L2 satisfy a relationship:
$$L 1 / L 2 = 1.05 - 3.$$

8. The battery according to claim 7, wherein L1=3 mm-10 mm; and/or, L2=0.5 mm-8 mm.

9. The battery according to claim 1, wherein the convex portions have a circumscribed ball, and the circumscribed ball comprises an outer surface; a flat area is formed between two adjacent convex portions, the outer surface has a spherical radius R1, a distance between the top of the convex portions and the flat area is R3, and the R1 and R3 satisfy a relationship:
$$R 3 < R 1.$$

10. The battery according to claim 9, wherein the outer surface has a surface area Q1, and a projection of the outer surface formed on the positive electrode current collector along a thickness direction of the electrode sheet has an area S1; the circumscribed ball further comprises an inner surface, the inner surface has a surface area Q2, and a projection of the inner surface formed on the positive electrode current collector along the thickness direction of the electrode sheet has an area S2; the Q1 and Q2 satisfy: Q1/Q2=1.02-1.21, and/or the S1 and S2 satisfy: S1/S2=1.02-1.21.

11. The battery according to claim 1, wherein an area sum of projections of the convex portions on the positive electrode current collector is S11, and an area of the positive electrode sheet is S, and the S11 and S satisfy a relationship:
$$0.02 \leq S 11 / S \leq 0.85 .$$

12. The battery according to claim 6, wherein the single-walled carbon nanotubes are interwoven to form a mesh structure and the positive electrode active material at the top of the convex portions is wrapped within the mesh structure.

13. The battery according to claim 7, wherein the positive electrode active material layer comprises a conductive agent, and the conductive agent comprises single-walled carbon nanotubes; the single-walled carbon nanotubes are interwoven to form a mesh structure and the positive electrode active material at the top of the convex portions is wrapped within the mesh structure.

14. The battery according to claim 8, wherein the positive electrode active material layer comprises a conductive agent, and the conductive agent comprises single-walled carbon nanotubes; the single-walled carbon nanotubes are interwoven to form a mesh structure and the positive electrode active material at the top of the convex portions is wrapped within the mesh structure.

15. The battery according to claim 9, wherein the positive electrode active material layer comprises a conductive agent, and the conductive agent comprises single-walled carbon nanotubes; the single-walled carbon nanotubes are interwoven to form a mesh structure and the positive electrode active material at the top of the convex portions is wrapped within the mesh structure.

16. The battery according to claim 12, wherein the single-walled carbon nanotubes have a diameter of 1 nm-1000 nm and a length of 1 μm-100 μm; and/or, based on a total mass of the positive electrode active material layer, the single-walled carbon nanotubes have a mass percentage of 0.5%-5%; and/or the single-walled carbon nanotubes in the positive electrode active material layer has a thickness of 10 nm-500 nm.

17. The battery according to claim 1, wherein the binder comprises at least one of polyvinylidene fluoride, vinylidene fluoride-hexafluoropropylene copolymer, styrene-acrylate copolymer, styrene-butadiene copolymer, polyamide, polyacrylonitrile, polyacrylic acid ester, polyacrylic acid, polyacrylate, sodium carboxymethyl cellulose, polyvinyl acetate, polyethylene pyrrolidone, polyethylene ether, polymethyl methacrylate, polytetrafluoroethylene or polyhexafluoropropylene.

18. (canceled)

19. The battery according to claim 1, wherein the negative electrode sheet comprises a negative electrode current collector and a negative electrode active material layer, and the negative electrode active material layer comprises a silicon-carbon composite material and/or a silicon-oxygen composite material.

20. The battery according to claim 1, wherein along a thickness direction of the positive electrode sheet, the convex portions have a size h3, and the concave portions have a size h4, and the h3 and the h4 satisfy a relationship:
$$h 3 / h 4 = 0.2 - 1.$$
